(19) United States
(12) Patent Application Publication
(10) Pub. No.: US 2017/0219406 A1
(43) Pub. Date: Aug. 3, 2017

(54) METHOD FOR MONITORING THE FILLING OF RAILWAY TANK CARS

(71) Applicant: ZAKRYTOE AKTCIONERNOE OBSCHESTVO "PETROLEUM ANALISTS", Moscow (RU)

(72) Inventors: Sergey Aleksandrovich AKIMOV, Moscow region (RU); Andrey Nikolaevich KOZLOV, Omsk (RU); Sergey Gennadevich KRASNOSHTANOV, Irkutskaya (RU)

(21) Appl. No.: 15/515,368

(22) PCT Filed: Oct. 2, 2015
(86) PCT No.: PCT/RU2015/000640

§ 371 Date: Mar. 29, 2017

(30) Foreign Application Priority Data
Oct. 3, 2014 (RU) 2014140104

(51) Int. Cl. G01F 23/04; G01F 23/22

(52) U.S. Cl. CPC G01F 23/04; G01F 23/22

(57) ABSTRACT

The invention relates to the field of measurement technology, and specifically to methods for monitoring the filling of railway tanks with liquid products, petroleum, petroleum products, petrochemical products, and food products, and may be used for monitoring the level to which railway tank cars are filled during the loading of liquid products itself in order to avoid (prevent) the overfilling or underfilling of tank cars. A method for monitoring the level to which railway lank cars are filled during the loading of liquid products is characterized in that, prior to beginning to fill a tank, a calculated tank loading level (H₁) is determined on the basis of the calculated temperature (t°_{calculated}) of a product to be loaded, the calculated loading level (H₁) is marked with the help of a load level monitoring device, which device includes a rod having a bar which is mounted at the calculated loading level (H₁), and which device is positioned within the tank. The next step involves visually monitoring the moment at which the level of the product to be loaded reaches the calculated loading level (H₁) marked by the bar. During loading of the product, a thermal imaging device is used for measuring the actual temperature (t°_{current}) of the product to be loaded, wherein the calculated tank loading level (H₁) is adjusted if the actual temperature (t°_{current}) increases or decreases relative to the calculated temperature (t_{calculated}). A device for monitoring the level to which railway tank cars are filled during the loading of liquid products includes, positioned inside a tank, a rod with a bar, which bar is mounted at the calculated tank loading level (H₁), and a thermal imaging device, intended for measuring the temperature of the product to he loaded. The technical result consists in increasing tank loading precision by monitoring the actual temperature of a product to be loaded, and adjusting a calculated loading level if the temperature changes relative to the calculated temperature.

### FIELD OF THE INVENTION

The invention relates to the field of measurement technology, and specifically to methods for monitoring the loading of railway tank cars with liquid products, such as oil, petroleum products, petrochemical products, and food products, and can be used to monitor the loading level of the rail tank cars directly during the process of filling with liquid products in order to avoid (prevent) overfilling or underfilling of the tank cars.

### PRIOR ART

A method of remote detection of the commercial drawbacks when filling railway oil cars is known, which consists in “on the fly” inspection, during which tank cars filled with oil products are moved into the field of view of a thermal imaging device to obtain a thermal image thereof and compare the contour image of the tank car with its scale image from the database. Then, the filling level of the tank car is detected on the thermal image and compared with the required level to establish the fact of overfilling or underfilling with petroleum products (patent RU2340946 C1. publication date: Jun. 10, 2006).

Another method for detecting incorrect loading of the railway tank cars is known, which consists in obtaining an “on the fly” thermal image of the tank car and determining the filling level, wherein a thermal imaging device is installed in such a way that the optical axis thereof forms an angle with the longitudinal center-plane of the tank in the vertical and horizontal planes, and the tank car is positioned entirely within its field of view; a thermal image of the tank car is recorded at its predetermined position within the field of view of the thermal imaging device; an image of the liquid surface face is observed; a liquid surface face level is measured relative to the top of rail by plotting on a thermal image a perpendicular line, located in the liquid surface face plane, to the lateral border of the liquid face at a distance from the edge of the lateral surface of the tank car, equal to the distance from a vertical plane, passing through the edges of the lateral surface of the tank car, to a vertical dipstick, located near the lateral surface of the tank car, and measuring the filling level based on the point of intersection between the image of said perpendicular line and the image of the dipstick; a tank car is identified based on its attributes, such as a tank car number; the type of a tank car is determined based on the railway database or accompanying documents (or a consignor list); the type and weight of the liquid cargo is determined; after which the filling level is calculated based on the tank car type and compared with the level determined based on the thermal image as described above (patent RU2517414 C2, publication date: May 27, 2014).

A disadvantage of the described methods consists in that they can only be used to monitor the actual level of the petroleum products, loaded into the tank cars, which are ready to be transported. These methods can be used, for example, by security services of the refineries to prevent petroleum theft. They can also help to reveal discrepancies between the data pertaining to the volumes of shipped product specified in the waybill and the volumes that were actually shipped. The use of the proposed device can “ease” the claim management work during acceptance of fuel contained in the tank cars, since the information related to the underfilling thereof will be obtained prior to opening the tank cars, which is important when considering claims in the future. In this case, the error in determining the loading level is quite high, since the liquid level tends to vary when the monitored tank cars are in motion. In addition, the quality of the thermal image is affected by uneven heating of the tank cars, sun glare and atmospheric precipitations. In addition, when the set of cars has already been formed for further shipment, and an incorrect loading of the tank cars, such as overfilling, is detected, which could result in exceeding the allowable load capacity of the tank cars, the latter will have to be uncoupled, which requires additional costly switching.

In addition, the prior art discloses a device for monitoring the loading level of the railway tank cars when filling them with oil products, which comprises a measuring rod with a bar, placed inside the tank at a calculated loading level to enable visual inspection of the tank car loading. Once the filling level reaches the calculated level, marked with the bar, tank car loading stops (patent RU132594 U1, publication date: Sep. 20, 2013).

A disadvantage of such method of monitoring the tank car loading is that during the process of loading the tank, no monitoring of the actual temperature of the loaded product is performed, which affects the calculated loading level. Initially, the calculated loading level of the tank car is determined based on the product properties, such as the temperature of the product to be filled and its density, which are known at a certain time. However, during product loading into the tank, its actual temperature may differ from the calculated temperature by being lower or higher. When the product temperature changes, the calculated level should be adjusted to prevent overfilling of the tank.

### IMPLEMENTATION OF THE INVENTION

The problem to be solved by the proposed invention is to provide a method for monitoring the loading level of the railway tank cars during filling with liquid products, which would account for change in the parameters of the filled product.

The technical result achieved by implementing the proposed invention consists in providing improved accuracy of the tank car loading due to monitoring of the actual temperature of the filled product and adjustment of the calculated loading level of the tank, should the temperature of the filled product change with respect to the calculated temperature, as well as in providing an expanded range of technical means for monitoring the loading level of the railway tank cars with liquid products in the process of filling, which would allow adjusting the loading level based on the changes in the filled product temperature. which reduces the likelihood of underfilling or overfilling a tank car with the loaded products and results in increased tank car filling efficiency.

The claimed technical result is achieved by utilizing a method for monitoring the level to which railway tank cars are filled during the loading of liquid products, which is characterized by the fact that prior to beginning to fill a tank car with liquid products, a calculated tank car loading level (H₁) is determined based on the calculated temperature (t°_{calculated}) of the product to be loaded, and the calculated loading level (H₁) is marked by using a loading level monitoring device, which includes a rod having a bar, which is mounted at the calculated loading level (H₁), and which is positioned within the tank car to enable visual monitoring of the moment at which the level of the loaded product reaches the calculated loading level (H₁) marked by the bar. During loading of the product, a thermal imaging device is used for measuring the actual temperature (t°_{current}) of the filled product, and the calculated tank car loading level (H₁) is adjusted if the actual temperature (t°_{current}) increases or decreases relative to the calculated temperature (t°_{calculated}).

Furthermore, in the particular embodiment of the invention, said thermal imaging device is provided with IP54 protection.

Furthermore, in another particular embodiment of the invention, said loading monitoring device is placed on the drain valve of the tank car.

Furthermore, in yet another particular embodiment of the invention, the measurement of the actual temperature (t°_{current}) of the loaded product is conducted through the open tank filler.

Furthermore, in yet another particular embodiment of the invention, the measurement of the actual temperature (t°_{current}) of the loaded product is conducted by way of measuring the heating temperature of the wall of the tank car shell.

In addition, the technical result is achieved due to the fact that the device for monitoring the loading level of the railway tank cars during filling with liquid products includes a rod having a bar, positioned inside the tank car and installed at the calculated tank car loading level (H₁), and a thermal imaging device intended for monitoring the temperature of the loaded product.

Furthermore, in the particular embodiment of the invention, said thermal imaging device is placed above the tank car port.

Furthermore, in another particular embodiment of the invention, said thermal imaging device is positioned in such a way as to ensure the possibility of measuring the heating temperature of the wall of the tank car shell.

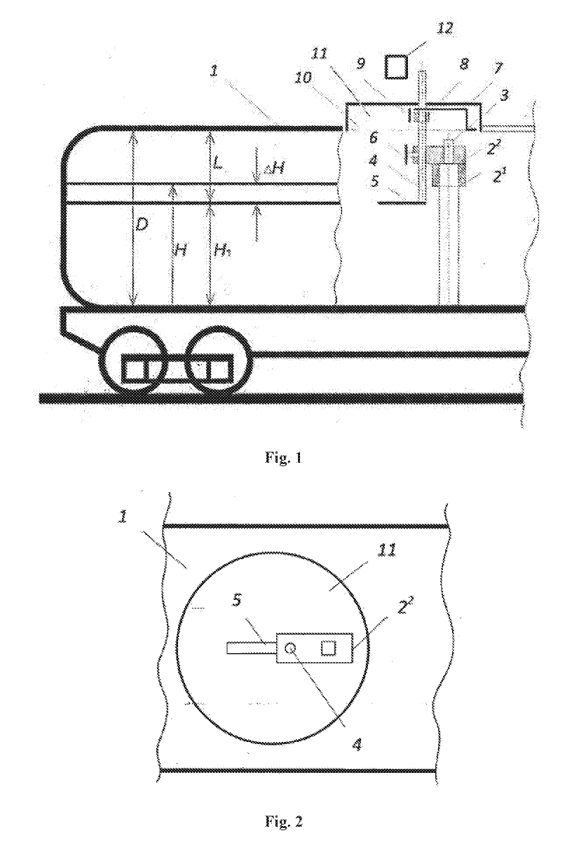

FIG. 1—fragment of the tank car shell with installed loading monitoring device;

FIG. 2—fragment of the tank car shell with installed loading monitoring device (top view).

The proposed method for monitoring the loading of the railway tank cars during filling with liquid products such as crude oil; petroleum products, in particular gasoline, heavy oil, diesel fuel, oil; and petrochemical products such as acetone, alcohols, esters, and food products (hereinafter—product) can be realized by using known means and methods. In particular, a device for monitoring the loading of the railway tank cars according to the patent RU132594 (publication date: Sep. 20, 2013) can be used as a device for marking the calculated tank car loading level (H₁).

A device for monitoring the loading level of the tank car (1) (FIG. 1) includes a base (mounting part) for mounting the device on a shaft (3) for opening of the bottom drain valve positioned inside the tank car shell (1). The base represents a part made of a polymeric material, such as fluoroplastic or kaprolon, and consists of a bottom section (2¹), made in the form of a cylinder, and an upper section (2²), made in the form of a parallelepiped, Parts (2¹) and (2²) of the base are provided with the openings that mimic the shape of the upper part of the shaft (3) for opening of the bottom drain valve, which ensures rigid attachment of the device and allows eliminating spinning of the device in the process of filling the tank car with petroleum products. Since the shaft (3) for opening of the bottom drain valve is present on all types of tank cars, it was selected as a support for mounting the proposed device. The device also includes a rod (4) with a horizontal bar (5), which is secured to the lower end of said rod and is provided with a measuring scale (not shown on the drawing).

The rod (4) represents a hollow tube made of stainless steel or duralumin. The upper portion (2²) of the base is provided with a through hole for accommodating the rod (4), which enables the vertical movement thereof, while the horizontal bar (5) can be installed within the tank car shell (1) at any desired (calculated) loading level (H₁). The upper portion (2²) of the base is provided with a retainer (6), which in the particular embodiment can be made in the form of a clamping screw, which secures the rod (4) in any given position. The upper portion of the rod (4) is provided with a bar (7), which has an S-shape in the particular embodiment and is secured to the cylindrical sleeve (8), made of a polymeric material, such as fluoroplastic or kaprolon, which enables the movement of the bar (7) along the rod (4). The sleeve (8) is provided with a clamp (9), embodied as a clamping screw in the particular embodiment, which secures the bar (7) in any given position.

### Implementation of the Method for Monitoring the Loading of the Railway Tank Cars in the Process of Filling with Liquid Products

Before starting the loading; of the tank car (1), in order to prevent overloading thereof (FIG. 1), it is necessary to first calculate the maximum allowable loading level H of the tank car (1). The maximum allowable loading level H (cm) is the level of the product in the tank car (1), which must be achieved in the process of loading. Depending on the location of the monitoring services to ensure proper loading; of the railway tank cars (1), the maximum allowable loading level H level of the tank car (1) is defined by either a client (using their program), or an employee of the service company, which provides services to monitor the tank car loading, based on the known technical characteristics of the tank car (1), properties of the loaded product and a known algorithm. To determine the maximum allowable loading level H of the tank car (1), one shall use the density (ρ_{calculated}) and temperature (t°_{calculated}) of the product in the product tank, which will be used to fill the tank car (1). A known capacity of the tank car (1) is divided by the density (ρ_{calculated}) of the loaded product to obtain the maximum volume of the loaded product, which is then converted to the corresponding maximum allowable loading level H (cm) for each type of the railway tank cars (1) using a calibration table (“Railway tank car calibration tables;” Russian Railways LLC, Morkniga, 2010 to replace CALIBRATION TABLES, 2003). However, when loading the tank car (1), the maximum allowable loading level H is reduced by the amount of AH to produce a required (calculated) loading level H₁ (cm)=H−ΔH. The reduction of the loading level of the tank car (1) by the amount of ΔH is caused by the error in determining the density and temperature of the product in the product tank, error in measuring the shell diameter of the tank car (1) and other factors. During the next stage of the tank car (1) preparation for filling, the difference between the inner shell diameter D of the tank car (1) and the required (calculated) filling level H₁ is calculated. This allows determining the distance L (cm)=D−H₁ from the upper generating line (10) of the tank car (1) shell to the required (calculated) filling level H₁.

Next, the calculated distance L must be set on the loading level monitoring device. To do this, the upper bar (7) is moved along the rod (4) until and installed at the distance L from the lower horizontal bar (5) on the measuring scale, after which the bar (7) is secured in this position with the clamping screw (9). After setting the distance to L, the device is then mounted on the shaft (3) for opening the bottom drain valve. After installing the device on the shaft (3), a loading rack operator or a member of the service company moves the rod (4) in such a way that the upper bar (7) is set at the level of the upper generating line (10) of the tank car (1) shell. In this case, the horizontal bar (5) will be positioned at the calculated loading level H₁ and serve as a visual guide for the operator, standing on the loading rack on top of the tank car, who will be able to see the horizontal bar (5) in the cross-section of the filler (11) of the tank car (1) (FIG. 2). Once the required (calculated) loading level H₁ is fixed, the product can be filled. During the product filling, the operator will he using the thermal imaging device (12) to monitor the current temperature (t°_{current}) of the loaded product. Monitoring of the temperature of the loaded product can be conducted by the operator through the open tank filler (11), if located on the loading rack on top of the tank car (1), or by measuring the heating temperature of the wall of the tank car (1) shell, if located outside the loading rack. Since the filled product is in direct contact with the inner surface of the wall of the tank car (1) shell, the wall temperature of the tank car shell will be equal to that of the product, and vice versa.

Furthermore, in accordance with the requirements of par. 5.7.2.1 of the GOST R 8.595-2004 “Weight of oil and oil products. General requirements for measurement techniques,” “when calculating the weight of the product when measuring the product volume in the capacity measures and gross capacity measures, and subsequently normalizing the product volume and density measurements based on the standard conditions, the wall temperature T_{wall} of the capacity measure is assumed to be equal to the product temperature within this capacity measure.”

If the current temperature t°_{current} becomes lower or greater than the calculated temperature t°_{calculated}, the operator shall make a decision of whether the adjustment of the required (calculated) filling level H₁ is necessary. If t°_{calculated}<t°_{current}, then the calculated level at t°_{current} will be higher than the established loading level H₁ and the tank car (1) will be underloaded. In this case, the operator makes a decision to fill the tank car (1) to a few centimeters above the required (calculated) filling level H₁, marked by the bar (5). If t°_{calculated}>t°_{current}, then the calculated loading level at t°_{current} will be lower than the established loading level H₁ and there is a possibility that the tank car (1) will be overloaded. In this case, the operator makes a decision to fill the tank car (1) to a few centimeters below the required (calculated) loading level H₁, marked by the bar (5). It was experimentally found that when the temperature of the loaded product changes by 5° C. relative to t°_{calculated}, the calculated loading level of the tank will change by 1-2 cm. Adjustment of the filling level H₁ is performed by sliding the bar (7) along the rod (4).

### Implementation of the Method is Evidenced, but Not Limited to the Following Examples

### Example 1

### Calculation of the Tank Car Loading Level Using Heavy Oil M100

Initial data: Tank car type 62; load capacity, P—60 tons; product density in the product reservoir ρ_{calculated} at t=15° C. 0.9500 g/cm³; product temperature in the product tank t°=75° C.; calculated tank car loading efficiency—97.6%,

1. To exclude the possibility of overloading the tank car, the temperature margin is set: t°_{calculated} 75° C.-5° C.=70° C.

2. The maximum possible volume of the loaded product V, m³ inside the tank car is calculated based on ρ_{calculated} and t°_{calculated} using the following formula:

$$V = \frac{P}{\begin{matrix}( ( 1 + ( 2 * 0.0000125 + 0.0000125 ) * \\ ( {t}_{calculated}^{o} - 20 ) ) * CLT * {ρ}_{calculated} )\end{matrix}} , \qquad ( 1 )$$

where: CLT is the correction coefficient, which accounts for the temperature effect on the product volume inside the railway tank car once the measured product volume is normalized based on the standard conditions, and is determined according to ASTM D 1250 “Standard guide for use of the petroleum measurement tables”).

After substituting the known values into the formula (1), the following value is obtained:

$$V = \frac{60}{\begin{matrix}( ( 1 + ( 2 * 0.0000125 + 0.0000125 ) * ( 70 - 20 ) ) * \\ 0.960028 * 0.9500 )\end{matrix}} = 65.664 {m}^{3} .$$

3. The required volume of the loaded product relative to the maximum allowable volume is calculated as follows:

V_{req}=65.664*0.976=64.088 m³.

4. Using the calibration tables, the calculated loading level of the tank car is determined: H₁=254.3 cm, which corresponds to the required volume V_{req}.

5. The distance is determined as follows: L=300 (tank car shell diameter, D)−254.3 (calculated loading level, H₁)+11 cm (adjustment for the bend height of the bar (9))=56.7 cm (rounded up to 57 cm).

6. Distance L is set using the loading monitoring device by sliding the bar (7) along the rod (4) and marking the calculated loading level H₁.

### Example 2

### Calculation of the Tank Car Loading Level Using Methyl Tertiary Butyl Ether (MTBE)

Initial data: Tank car type—72; load capacity (planned cargo weight), P—52.0 tons; product density in the product reservoir ρ_{calculated} at t==21° C.—0.7375 g/cm³; product temperature in the product tank t°=21° C.; calculated tank car loading efficiency—100.0%.

1. The maximum possible volume of the loaded product V, m³ inside the tank car is calculated based on ρ_{calculated} and t°_{calculated} using the following formula:

$$V = \frac{P}{\begin{matrix}( ( 1 + ( 2 * 0.0000125 + 0.0000125 ) * \\ ( {t}_{calculated}^{o} - 20 ) ) * {ρ}_{calculated} )\end{matrix}} , \qquad ( 1 )$$

After substituting the known values into the formula (1), the following value is obtained:

$$V = \frac{52.0}{\begin{matrix}( ( 1 + ( 2 * 0.0000125 + 0.0000125 ) * \\ ( 21 - 20 ) ) * 0.7375 )\end{matrix}} = 70.506 {m}^{3} .$$

2. The required volume of the loaded product relative to the maximum allowable volume is calculated as follows:

V_{req}=70.506*1.00=70.506 m³.

3. Using the calibration tables, the calculated loading level of the tank car is determined: H₁=283.2 cm, which corresponds to the required volume V_{req}.

4. The distance is determined as follows: L=300 (tank car shell diameter, D)−283.2 (calculated loading level, H₁)+11 cm (adjustment for the bend height of the bar (9)):=27.8 cm (rounded up to 28 cm).

5. Distance L is set using the loading monitoring device by sliding the bar (7) along the rod (4) and marking the calculated loading level H₁.

### Example 3

### Calculation of the Tank Car Loading Level Using Styrene (Phenylethylene, Vinylbenzene, Ethenylbenzene)

Initial data: Tank car type—66; load capacity, P—66.0 tons; product density in the product reservoir ρ_{calculated} at t=22° C. 0.9044 g/cm³; product temperature in the product tank=22° C.; calculated tank car loading efficiency—98.0%.

1. The maximum possible volume of the loaded product V, m³ inside the tank car is calculated based on ρ_{calculated} and t°_{calculated} using the following formula:

$$V = \frac{P}{\begin{matrix}( ( 1 + ( 2 * 0.0000125 + 0.0000125 ) * \\ ( {t}_{calculated}^{o} - 20 ) ) * {ρ}_{calculated} )\end{matrix}} , \qquad ( 1 )$$

After substituting the known values into the formula (1), the following value is obtained:

$$V = \frac{66.0}{\begin{matrix}( ( 1 + ( 2 * 0.0000125 + 0.0000125 ) * \\ ( 22 - 20 ) ) * 0.9044 )\end{matrix}} = 72.971 {m}^{3} .$$

2. The required volume of the loaded product relative to the maximum allowable volume is calculated as follows:

V_{req}=72.971*0.98=71.512 m³.

3. Using the calibration tables, the calculated loading level of the tank car is determined: H₁=251.1 cm, which corresponds to the required volume V_{req}.

4. The distance is determined as follows: L=320 (tank car shell diameter, D)−251.1 (calculated loading level, H₁)+11 cm (adjustment for the bend height of the bar (9))=79.9 cm (rounded up to 80 cm).

5. Distance L is set using the loading monitoring device by sliding the bar (7) along the rod (4) and marking the calculated loading level H₁.

### Example 4

### Calculation of the Tank Car Loading Level Using Biofuel

Initial data: Tank car type—79; load capacity (planned cargo weight), P—65.0 tons; product density in the product reservoir ρ_{calculated} at t=35° C.−0.8500 g/cm³; product temperature in the product tank t°=35° C.; calculated tank car loading efficiency—97.0%.

1. The maximum possible volume of the loaded product V, m³ inside the tank car is calculated based on ρ_{calculated} and t°_{calculated} using the following formula:

$$V = \frac{P}{\begin{matrix}( ( 1 + ( 2 * 0.0000125 + 0.0000125 ) * \\ ( {t}_{calculated}^{o} - 20 ) ) * {ρ}_{calculated} )\end{matrix}} , \qquad ( 1 )$$

After substituting the known values into the formula (1), the following value is obtained:

$$V = \frac{65.0}{\begin{matrix}( ( 1 + ( 2 * 0.0000125 + 0.0000125 ) * \\ ( 35 - 20 ) ) * 0.8500 )\end{matrix}} = 76.428 {m}^{3} .$$

2. The required volume of the loaded product relative to the maximum allowable volume is calculated as follows:

V_{req}=76.428*0.97=74.135 m³.

3. Using the calibration tables, the calculated loading level of the tank car is determined: H₁=288.4 cm, which corresponds to the required volume V_{req}.

4. The distance is determined as follows: L=300 (tank car shell diameter, D)−288.4 (calculated loading level, H₁)+11 cm (adjustment for the bend height of the bar (9))=22.6 cm (rounded up to 23 cm).

5. Distance L is set using the loading monitoring device by sliding the bar (7) along the rod (4) and marking the calculated loading level H₁.

### Example 5

### Calculation of the Adjustment to the Tank Car Loading Level when the Product Temperature Changes by 5° C. (Product Heavy Oil M100)

Initial data: Tank car type—62; load capacity, P—60.0 tons; heavy oil M100 density in the product reservoir under the standard conditions (t°=15° C.) ρ₁₅=0.9583 g/cm³; product temperature in the product tank t°_{calculated}=80° C.; calculated tank car loading efficiency 98.0%.

1. The maximum possible volume of the loaded product V, m³ inside the tank car is calculated based on ρ₁₅, t°_{calculated} and volumetric correction coefficient CTL₁₅, which accounts for the temperature effect on the product volume inside the railway tank car, using the following formula:

$$V = \frac{P}{\begin{matrix}( ( 1 + ( 2 * 0.0000125 + 0.0000125 ) * \\ ( {t}_{calculated}^{o} - 20 ) ) * {CTL}_{15} * {ρ}_{15} )\end{matrix}} , \qquad ( 1 )$$

CLT₁₅=0.95320 is determined from the ASTM D 1250 Tables.

After substituting the known values into the formula (1), the following value is obtained:

$$V = \frac{60.0}{\begin{matrix}( ( 1 + ( 2 * 0.0000125 + 0.0000125 ) * \\ ( 80 - 20 ) ) * 0.95320 * 0.9583 )\end{matrix}} = 65.538 {m}^{3} .$$

2. The required volume of the loaded product relative to the maximum allowable volume is calculated as follows:

V_{req}=65.537*0.98=64.227 m³.

3. Using the calibration tables, the calculated loading level of the tank car is determined: H₁=248.2 cm, which corresponds to the required volume V_{req}.

4. The actual measured product temperature during filling is t°_{actual}=75° C.

4. The maximum possible volume of the loaded product V, m³ inside the tank car is calculated based on ρ₁₅, t°_{actual} and volumetric correction coefficient CTL₁₅, which accounts for the temperature effect on the product volume inside the railway tank car, using the following formula:

$$V = \frac{P}{\begin{matrix}( ( 1 + ( 2 * 0.0000125 + 0.0000125 ) * \\ ( {t}_{calculated}^{o} - 20 ) ) * {CTL}_{15} * {ρ}_{15} )\end{matrix}} , \qquad ( 1 )$$

CTL₁₅=0.95684 is determined from the ASTM D 1250 Tables.

After substituting the known values into the formula (1), the following value is obtained:

$$V = \frac{60.0}{\begin{matrix}( ( 1 + ( 2 * 0.0000125 + 0.0000125 ) * \\ ( 75 - 20 ) ) * 0.95684 * 0.9583 )\end{matrix}} = 65.300 {m}^{3} .$$

5. The required volume of the loaded product relative to the maximum allowable volume is calculated as follows:

V_{corr}=65.300*0.98=63.994 m³.

ΔV=V_{req}−V_{corr}=64.227 m³−63.994 m³=0.231 m³.

6. Using the calibration tables, the calculated loading level of the tank car is determined: H₁=247.2 cm, which corresponds to the required volume V_{req}. The level adjustment corresponding to the temperature change of 5° C. will be: 247.2 cn−248.2 cm=−1 cm.

ΔV=V_{req}−V_{corr}

ΔV=64.226 m³−63.994 m³=0.230 m³.

The above shown examples evidence the implementation of the proposed invention for various types of liquid products, but are not limited thereto. The claimed method can he used to monitor the tank car loading level when filling with any liquid products by using the corresponding known coefficients accounting for thermal expansion of various types of products, as well as known temperature (t°), density (ρ) and volume (V) ratios of liquid products. For example, the density of milk is calculated at 20° C., and if the temperature changes by 1° C., this density is recalculated based on the coefficient of thermal expansion, which equals 0.0002 per 1° C. (see: Ye. Yu. Pyatkovskaya, A. V. Vinogradova “Merchandising and customs examination of food products of animal origin,” St. Petersburg, NIU IMTO, 2012, p. 19).

### Example 6

### Calculation of the Tank Car Loading Level without Accounting for the Product Temperature Change During Filling and No Adjustment of the Calculated Level is Performed (Product Heavy Oil M100)

Initial data: Tank car type=62; load capacity, P—60.0 tons; heavy oil M100 density in the product reservoir under the standard conditions (t°=15° C.) ρ₁₅=0.9583 g/cm³; product temperature in the product tank t°_{calculated}=80° C.; calculated tank car loading efficiency−99.0%.

1. The maximum possible volume of the loaded product V, m³ inside the tank car is calculated based on ρ₁₅, t°_{calculated} and volumetric correction coefficient CTL₁₅, which accounts for the temperature effect on the product volume inside the railway tank car, using the following formula:

$$V = \frac{P}{\begin{matrix}( ( 1 + ( 2 * 0.0000125 + 0.0000125 ) * \\ ( {t}_{calculated}^{o} - 20 ) ) * {CTL}_{15} * {ρ}_{15} )\end{matrix}} , \qquad ( 1 )$$

CTL₁₅==0.95320 is determined from the ASTM D 1250 Tables.

After substituting the known values into the formula (1), the following value is obtained:

$$V = \frac{60.0}{\begin{matrix}( ( 1 + ( 2 * 0.0000125 + 0.0000125 ) * \\ ( 80 - 20 ) ) * 0.95320 * 0.9583 )\end{matrix}} = 65.538 {m}^{3} .$$

2. The required volume of the loaded product relative to the maximum allowable volume is calculated as follows:

V_{req}=65.537*0.99=64.882 m³ or 59.4 tons.

3. Using the calibration tables, the calculated loading level of the tank car is determined: H₁=259.8 cm, which corresponds to the required volume V_{req}.

4. The distance is determined as follows: L=300 (tank car shell diameter, D)−259.8 (calculated loading level, H₁)+11 cm (adjustment for the bend height of the bar (9))=51.2 cm (rounded up to 51 cm).

5. Distance L is set using the loading monitoring device and the calculated loading level H₁ is marked.

6. The tank car is filled based on the calculated H₁=259.8 cm.

7. The actually measured product temperature during loading was t°_{current}=65° C.

8. No level adjustment was performed, and the cargo weight at 65° C. can he determined as follows:

M=V*(1+(2*0.0000125+0.0000125)*(t°_{current}−20))*CTL₁₅*ρ₁₅)

CTL₁₅=0.96410 is determined from the ASTM D 1250 Tables.

M=64.882*(1+(2*0.0000125+0.0000125)*(65−20))*0.9641*0.9583=60.046 tons

9. The weight of the loaded product was 60.046 tons, which is an overload.

Based on the above example 6, it can be concluded that failure to adjust the current temperature of the filled product results in overloading of the tank car.

The implementation of the proposed method of monitoring the loading of the railway tank cars during filling with liquid products can be realized by using any modification of the device for monitoring of the tank car loading according to the patent RU132594 U1, publication date: Sep. 20, 2013 or a similar device without exceeding the scope of legal protection or the claims.

Thus, the above examples do not limit e scope of the legal protection provided by the claims, but in fact confirm the possibility of implementation of the invention.

Thus, the proposed method is realized by monitoring the loading of a tank car and adjusting the loading level if the temperature of the loaded product changes with respect to the calculated temperature, which reduces the likelihood of product underfilling or overfilling and results in improved loading efficiency of the loaded tank car.

1-8. (canceled)

9. A method for monitoring a loading level of a railway tank car during filling with a liquid product, comprising:
determining, prior to filling the railway tank car, a calculated tank car loading level (H₁) based on the calculated temperature (t°_{calculated}) of the liquid product;
marking the calculated loading level (H₁) using a loading level monitoring device, which includes a rod having a bar mounted at the calculated loading level (H₁);
positioning the loading level monitoring device within a shell of the railway tank car;
mounting the bar at the calculated loading level (H₁);
visually monitoring a level of the liquid product by using the bar;
measuring an actual temperature (t°_{current}) of the liquid product using a thermal imaging device and while filling the shell with the liquid product; and
adjusting the calculated tank car loading level (H₁) if the actual temperature (t°_{current}) increases or decreases relative to the calculated temperature (t°_{calculated}).

10. The method according to claim 9, further comprising mounting said loading level monitoring device on a drain valve associated with the railway tank car.

11. The method according to claim 9, wherein the actual temperature (t°_{current}) of the liquid product is measured through an open tank filler associated with the railway tank car.

12. The method according to claim 9, wherein the actual temperature (t°_{current}) of the liquid product is measured by measuring a temperature of a wall of the tank car shell.

13. An apparatus for monitoring a loading level of a railway tank car during filling with a liquid product, comprising:
a rod positioned inside a shell of the railway tank car, the rod having a bar mounted at a calculated loading level (H₁) of the liquid product in the shell of the tank car; and
a thermal imaging device positioned to measure a temperature of the liquid product.

14. The apparatus according to claim 13, wherein said thermal imaging device is positioned above a tank filler associated with the shell of the tank car.

15. The apparatus according to claim 13, wherein said thermal imaging device is positioned to measure a temperature of a wall of the shell of the tank car.
